(19) United States
(12) Patent Application Publication
(10) Pub. No.: US 2023/0198417 A1
(43) Pub. Date: Jun. 22, 2023

(54) ENERGY RECOVERY AUXILIARY CIRCUIT FOR DC/DC RESONANT POWER CONVERTER TOPOLOGIES

(71) Applicant: HUAWEI TECHNOLOGIES CO., LTD., Shenzhen (CN)

(72) Inventors: Grover Victor TORRICO-BASCOPÉ, Kista (SE); Carlos MARTINEZ, Kista (SE)

(21) Appl. No.: 18/169,948

(22) Filed: Feb. 16, 2023

Related U.S. Application Data
(63) Continuation of application No. PCT/EP2020/072989, filed on Aug. 17, 2020.

(51) Int. Cl. H02M 3/335; H02M 1/096; H02M 1/32; H02M 1/14

(52) U.S. Cl. CPC H02M 3/33571; H02M 1/096; H02M 1/325; H02M 1/143

(57) ABSTRACT

A power converter apparatus employs an energy recovery auxiliary circuit to suppress overvoltage oscillations and achieve high efficiency in a resonant LLC power converter system having high power density. The power converter apparatus includes an inverter configured to receive a DC input power and produce an AC voltage, a resonant tank including a resonant inductor and a resonant capacitor coupled between the AC voltage and a primary winding of a transformer, a rectifier configured to produce a DC output power coupled to a secondary winding of the transformer. The power converter suppresses overvoltage oscillations on rectifier switches by employing an energy recovery auxiliary circuit to transfer, during a transition period, current from the secondary side to a clamping capacitor conductively coupled to the primary side of the converter. The energy is then recovered during a subsequent power transfer cycle, thereby improving overall efficiency of the power converter.

### CROSS-REFERENCE TO RELATED APPLICATIONS

This application is a continuation of International Application No. PCT/EP2020/072989, filed on Aug. 17, 2020, the disclosure of which is hereby incorporated by reference in its entirety.

### TECHNICAL FIELD

The aspects of the disclosed embodiments relate generally to power converter apparatus, and more particularly to high frequency parallel/series resonant DC/DC converters.

### BACKGROUND

Current trends in DC/DC power converters are toward high efficiency and high power density. A promising topology for achieving these goals is known as an LLC resonant DC/DC converter. This topology uses an inverter to receive a DC power and generate an AC voltage, which is used to drive an LLC resonant tank. The LLC resonant tank includes a resonant inductance, a resonant capacitance, and the primary of a transformer. A synchronous rectifier is coupled to the secondary of the transformer to produce a DC output power. To improve power density, it is desirable to operate these resonant converters at high frequencies. However, at higher frequencies, leakage inductances of the transformer secondary windings interact with stray capacitances of the secondary side switching devices resulting in undesirable overvoltage oscillations. These oscillations may damage the secondary side switching devices and can increase the cost of the converter. Conventional solutions for mitigating the secondary side ringing are based on adding active damping on the secondary side to supress these oscillations. Unfortunately, this approach results in increased converter cost and complexity as well as reduced efficiency.

Thus, there is a need to mitigate these harmful oscillations while maintaining desirable efficiency, reliability, and cost of the power converter apparatus. Accordingly, it would be desirable to provide an apparatus that addresses at least some of the problems described above.

### SUMMARY

Aspects of example embodiments are directed to a resonant LLC DC/DC power converter topology suitable for high power, high efficiency, and high power density applications. The aspects of the example embodiments provide a power converter topology that provides efficient DC to DC power conversion while supressing potentially harmful overvoltage oscillations on semiconductor switches used to rectify the output power. This and other objectives are addressed by the subject matter of the independent claims. Further advantageous modifications can be found in the dependent claims.

According to a first aspect, the above and further objectives and advantages are obtained by an apparatus. In one embodiment, the apparatus includes an inverter configured to receive a DC input power and produce an AC voltage. A first capacitor and a second capacitor are coupled in series between a positive DC input voltage and a negative DC input voltage forming a first central node between the first capacitor and the second capacitor. A transformer includes a primary winding and a secondary winding, where the primary winding is coupled to the first central node with a resonant inductor coupled between the AC voltage and the primary winding. The apparatus includes a rectifier coupled to the secondary winding and configured to produce a DC output power. An auxiliary circuit includes a first diode and a second diode coupled in series between the positive DC input voltage and the negative DC input voltage, and a clamping capacitor coupled between the resonant inductor and a central node located between the first diode and the second diode. The auxiliary circuit draws current from the secondary side during a transition time thereby supressing overvoltage oscillations on the synchronous rectifier switches. The energy is stored in a clamping capacitor and will be recovered during a subsequent power cycle of the converter. The auxiliary circuit supresses overvoltage ringing on the secondary side while maintaining high converter efficiency.

In a first possible implementation form of the apparatus according to the first aspect the inverter includes a first semiconductor switch and a second semiconductor switch coupled in series between the positive DC input voltage and the negative DC input voltage. Using a half-bridge inverter keeps the number of semiconductor switches to a minimum.

In a possible implementation form of the apparatus according to the first aspect, the secondary winding includes a center tap coupled to a first DC output voltage and the rectifier includes a third semiconductor switch coupled between a first end of the secondary winding and a second DC output voltage. A fourth semiconductor switch is coupled between a second end of the secondary winding and the second DC output voltage. The use of a center-tapped secondary winding and a half-bridge rectifier minimizes the number of semiconductor switches required for rectification.

In a possible implementation form of the apparatus according to the first aspect the rectifier includes a fifth semiconductor switch coupled between a first end of the secondary winding and a first DC output voltage, a sixth semiconductor switch coupled between the first end of the secondary winding and a second DC output voltage, a seventh semiconductor switch coupled between a second end of the secondary winding and the first DC output voltage, and an eighth semiconductor switch coupled between the second end of the secondary winding and the second DC output voltage. The energy recovery auxiliary circuit can effectively supress overvoltage oscillations in converters employing full-bridge rectification on the secondary side of the transformer.

In a possible implementation form of the apparatus according to the first aspect the apparatus includes a third diode coupled in parallel with the first capacitor, and a fourth diode coupled in parallel with the second capacitor. These parallel diodes provide overvoltage protection for the resonant capacitors.

According to a second aspect the above and further objectives and advantages are obtained by an apparatus. In one embodiment the apparatus includes an inverter configured to receive a DC input power and produce a first AC voltage and a second AC voltage. A resonant tank is coupled between the first AC voltage and the second AC voltage. The resonant tank includes a resonant inductor coupled in series with a resonant capacitor coupled to the primary winding of a transformer and a rectifier coupled to a secondary winding of the transformer. The rectifier is configured to produce a DC output power. An auxiliary circuit includes a first diode and a second diode coupled in series between a first DC input voltage and the first AC voltage having a first central node. A clamping capacitor (C_{C}) is coupled between a first end of the resonant inductor and the first central node. The auxiliary circuit supresses overvoltage oscillations which may occur within the rectifier during a transition time by drawing current from the secondary side, storing it on the clamping capacitor on the primary side, and recovering the stored energy during a subsequent power cycle.

In a possible implementation form of the apparatus according to the second aspect, the inverter includes a first semiconductor switch and a second semiconductor switch coupled in series between the positive DC input voltage and a negative DC input voltage configured to produce the second AC voltage. A third semiconductor switch and a fourth semiconductor switch are coupled in series between the positive DC input voltage and the negative DC input voltage and configured to produce the first AC voltage. A full-bridge inverter may be advantageously employed in the apparatus.

In a possible implementation form of the apparatus according to the second aspect the secondary winding includes a center tap coupled to a first DC output voltage. The rectifier includes a fifth semiconductor switch coupled between a first end of the secondary winding and a second DC output voltage, and a sixth semiconductor switch coupled between a second end of the secondary winding and the second DC output voltage. The use of half-bridge rectification minimizes the number of semiconductor switches required to rectify the DC output power.

In a possible implementation form of the apparatus according to the second aspect the rectifier includes a seventh semiconductor switch coupled between the first end of the secondary winding and the positive DC output voltage, an eighth semiconductor switch coupled between the first end of the secondary winding and the negative DC output voltage, a ninth semiconductor switch coupled between the second end of the secondary winding and the positive output voltage, and a tenth semiconductor switch coupled between the second end of the secondary winding and the negative output voltage. A full-bridge rectifier may be advantageously employed in the apparatus.

According to a third aspect the above and further objectives and advantages are obtained by a method. In one embodiment the method is configured for operating a DC/DC power converter where the converter includes an inverter configured to receive an input DC power and produce an AC power. A resonant tank is coupled to the AC power and includes a resonant inductor coupled to a primary winding of a transformer. A rectifier is coupled to a secondary side of the transformer and configured to produce an output power. A clamping capacitor is conductively coupled between the resonant inductor and the primary winding. The method includes synchronously operating the inverter and the rectifier to create a transition period followed by a power delivery period. The method then transfers, during the transition period, a current from the secondary side through the transformer to the primary winding and then to the clamping capacitor. Power stored on the clamping capacitor is released during a subsequent power delivery period back to the input power. The example method provides suppression of overvoltage oscillations on the secondary side and subsequently recovering energy thereby improving the overall efficiency of the power conversion.

These and other aspects, implementation forms, and advantages of the example embodiments will become apparent from the embodiments described herein considered in conjunction with the accompanying drawings. It is to be understood, however, that the description and drawings are designed solely for purposes of illustration and not as a definition of the limits of the disclosed invention, for which reference should be made to the appended claims. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

In the following detailed portion of the present disclosure, the invention will be explained in more detail with reference to the example embodiments shown in the drawings, in which like numerals indicate like elements and:

FIG. 1 illustrates a schematic diagram of an example symmetric LLC resonant power converter apparatus incorporating aspects of example embodiments;

FIG. 2 illustrates a conventional symmetric half-bridge LLC resonant converter topology;

FIG. 3 illustrates graphs showing the main converter waveforms associated with the resonant converter topology illustrated in FIG. 2;

FIG. 4 illustrates a graph showing overvoltage oscillations occurring on synchronous rectifier switches in the converter topology illustrated in FIG. 2;

FIG. 5 illustrates a symmetric LLC resonant converter topology incorporating aspects of example embodiments;

FIG. 6 illustrates freewheeling currents flowing in a symmetric LLC resonant converter topology incorporating aspects of example embodiments;

FIG. 7 illustrates graphs showing operating waveforms of an energy recovery auxiliary circuit incorporating aspects of example embodiments;

FIG. 8 illustrates graphs comparing rectifier current of conventional power converter topologies to the improved power converter topologies incorporating aspects of example embodiments;

FIG. 9 illustrates graphs comparing drain to source voltages of rectifier switches in conventional power converter topologies to improved power converter topologies incorporating aspects of example embodiments;

FIG. 10 illustrates a symmetric half-bridge resonant LLC converter topology with full-bridge rectification incorporating aspects of example embodiments;

FIG. 11 illustrates graphs comparing drain to source voltages of rectifier switches in conventional power converter topologies to improved power converter topologies incorporating aspects of the example embodiments;

FIG. 12 illustrates a full-bridge resonant LLC converter topology incorporating aspects of example embodiments;

FIG. 13 illustrates a full-bridge resonant LLC converter topology with full-bridge rectification incorporating aspects of example embodiments;

FIG. 14 illustrates a flow diagram of an example method for supressing overvoltage ringing in a resonant LLC converter topology incorporating aspects of example embodiments.

### DETAILED DESCRIPTION OF EXAMPLE EMBODIMENTS

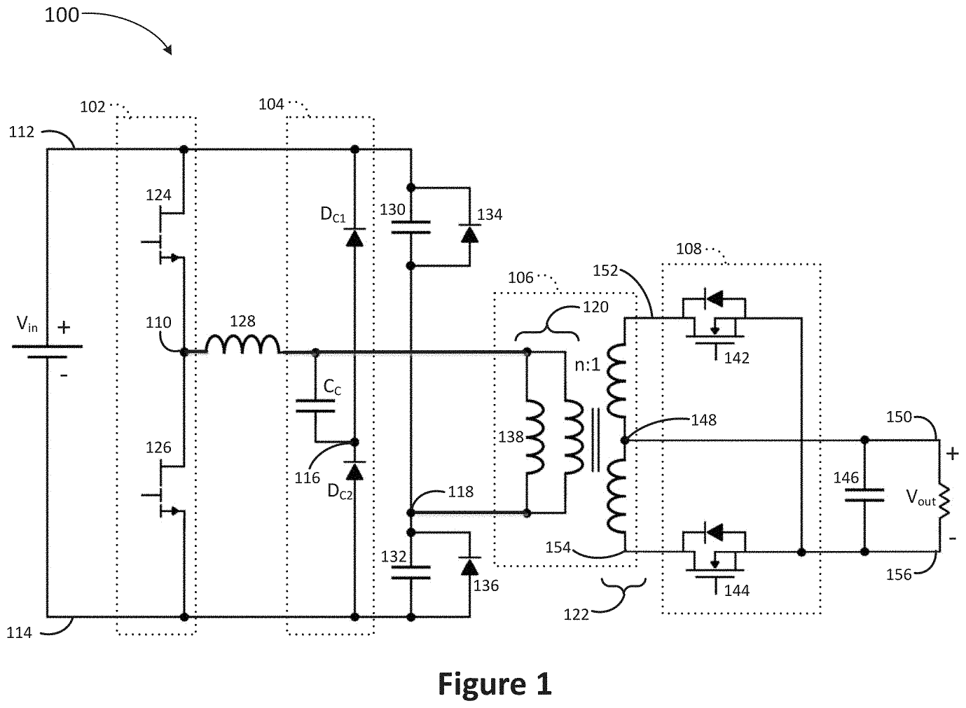

Referring to FIG. 1, a schematic diagram of an example power converter apparatus 100 incorporating aspects of example embodiments is illustrated. The power converter apparatus 100 of example embodiments is directed to a power converter topology, referred to more particularly herein as a symmetric LLC resonant power converter topology. The power converter apparatus 100 employs an energy recovery auxiliary circuit 104 configured to supress overvoltage oscillations occurring on the secondary side of the transformer 106. The example apparatus 100 is suitable for DC/DC power conversion applications where step-down and regulation of the output power Vₒᵤₜ is desired in power factor correction (PFC) applications. The apparatus 100 is especially suitable for generating a low voltage output power Vₒᵤₜ, as power used to supply computer server apparatus, for example.

As used herein the term “primary side” refers to power converter elements that are conductively coupled to a transformer's primary winding, and the term “secondary side” refers to power converter elements that are conductively coupled to a transformer's secondary winding. The primary side elements are magnetically coupled with secondary side elements. As used herein, a semiconductor switching device is considered to be “on” or in an “on state” when it is conducting current between its drain and source, and “off” or in an “off state” when it is not conducting current between its drain and source.

As shown in FIG. 1, the apparatus 100 includes an inverter 102 configured to receive a DC input power Vᵢₙ and produce an AC voltage 110. A first capacitor 130 and a second capacitor 132 are coupled in series between a positive DC input voltage 112 and a negative DC input voltage 114, with a first central node 118 formed between the first capacitor 130 and the second capacitor 132.

The apparatus 100 includes a transformer 106. The transformer 106 comprises a primary winding 120 and a secondary winding 122. The primary winding 120 is coupled to the first central node 118.

A resonant inductor 128 is coupled between the AC voltage 110 and the primary winding 120. A rectifier 108 is coupled to the secondary winding 122 and is configured to produce a DC output power Vₒᵤₜ.

The apparatus 100 includes an auxiliary circuit 104. The auxiliary circuit 104 comprises a first diode D_{C1} and a second diode D_{C2} coupled in series between the positive DC input voltage 112 and the negative DC input voltage 114. A clamping capacitor C_{C} is coupled between the resonant inductor 128 and a central node 116 between the first diode D_{C1} and the second diode D_{C2}. The auxiliary circuit 104 draws current from the secondary side during a transition time thereby supressing overvoltage oscillations on the synchronous rectifier switches. The energy is stored in the clamping capacitor C_{C} and will be recovered during a subsequent power cycle of the converter. Thus, the auxiliary circuit 104 supresses overvoltage ringing on the secondary side while maintaining high converter efficiency.

The example inverter 102 shown in FIG. 1 is coupled in parallel with the DC input power Vᵢₙ and uses a half-bridge inverter configuration implemented using an upper semiconductor switch 124 and a lower semiconductor switch 126, also referred to as inverter switches 124, 126, coupled in series between the positive input voltage 112 and the negative input voltage 114. In a power factor correction application, the inverter 102 may be operated for example at a fifty percent (50%) duty cycle to create an AC voltage at a central node 110, referred to as AC voltage 110, formed between the two switches 124, 126. Alternatively, as will be described further below, a full-bridge inverter configuration may be advantageously employed in certain embodiments.

In one embodiment, a resonant tank is formed by a resonant inductor 128, the primary winding 120 of a transformer 106 and a pair of capacitors 130, 132 coupled in series between the positive input voltage 112 and the negative input voltage 114. The resonant inductor 128 and primary winding 120 are coupled in series between the AC voltage 110 and a central node 118, which is located between the two series connected capacitors 130, 132.

In certain embodiments, a diode 134, 136 is connected in parallel with the respective capacitor 130, 132. The diodes 134, 136 provide a path for freewheeling current flowing during output overload or short-circuit conditions.

The example rectifier 108 of power converter apparatus 100 is coupled to the secondary winding 122 and configured to produce the DC output power Vₒᵤₜ. Using a center-tapped 148 secondary winding 122 allows a half-bridge rectifier to be coupled to the ends 152, 154 of the secondary winding 122 thereby minimizing the number of semiconductor switching devices 142, 144 used for rectification. The semiconductor switching devices 142, 144, also referred to as rectifier switches, may be operated synchronously with the inverter switches 124, 126. Synchronous operation ensures that power cycles and transition periods of the inverter 102 and rectifier 108 are aligned in time.

To reduce the size of magnetic components and maximize the power density of the power converter apparatus 100, the example inverter 102 is configured to operate at a high frequency, for example at about one megahertz (MHz) or above about one hundred kilohertz (kHz). At these higher frequencies, secondary effects of the transformer 106 become significant. As will be discussed further below, energy stored in the magnetizing inductance 138 aids zero voltage switching of the converter. A wide range of input power Vᵢₙ voltages and output power Vₒᵤₜ voltages can be supported by the apparatus 100 through the use of various transformer turns ratios. The transformer turns ratio is represented in FIG. 1 as “n:1”, where the number n may be varied as desired.

In the illustrated embodiment of apparatus 100, it is advantageous to include a filtering capacitor 146 coupled across the output power Vₒᵤₜ to remove high frequency components. Alternatively, other types of filters may be advantageously employed without straying from the spirit and scope of the present disclosure.

A drawback of conventional LLC resonant converter topologies occurs when they are operated at high frequencies. At these high frequencies, such as above 100 kHz, the leakage inductance of the transformer secondary winding interacts with the stray capacitances of the synchronous rectifier switches leading to potentially harmful overvoltage oscillations on the rectifier switches. To supress these oscillations and prevent their negative effects the example power converter apparatus 100 includes an energy recovery auxiliary circuit 104. The auxiliary circuit 104 includes a pair of diodes D_{C1} and D_{C2} coupled in series between the positive input voltage 112 and the negative input voltage 114. A clamping capacitor C_{C} is coupled between the resonant inductor 128 and a central node 116 formed between the series connected diodes D_{C1} and D_{C2}.

During a transition period, where all switching devices 124, 126, 142, 144 are off, current from the secondary winding 122 is transferred via a lower impedance path through the transformer 106 to the clamping capacitor C_{C}, thereby supressing the overvoltage oscillations that would otherwise occur on the secondary side of the transformer 106. During a subsequent power cycle, the energy is recovered from the clamping capacitor C_{C} and transferred back to the input power Vᵢₙ.

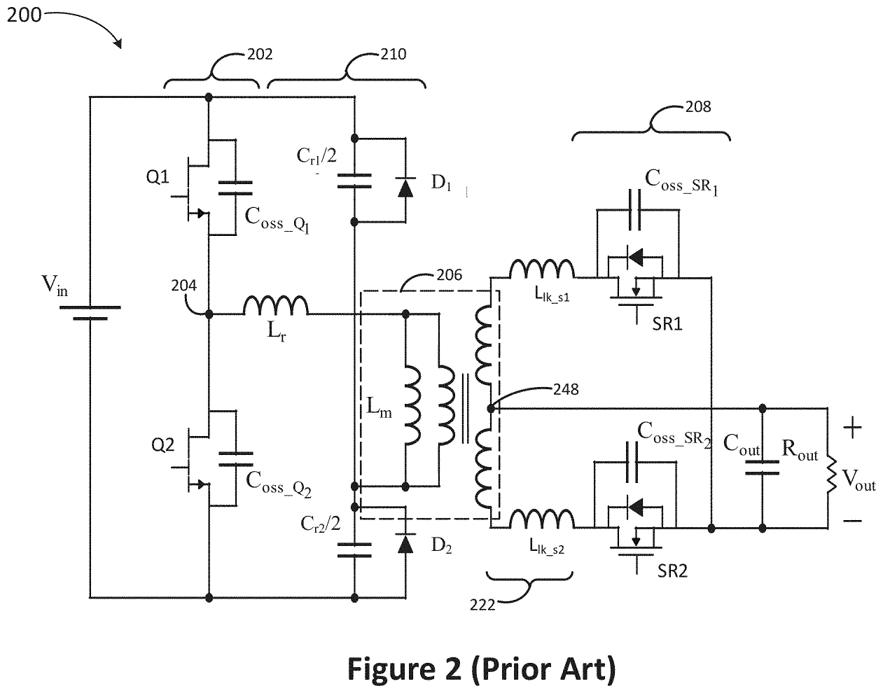

To better appreciate the operation of the energy recovery auxiliary circuit 104, it is instructive to look at the circuit dynamics of a conventional resonant LLC converter, with reference to FIGS. 2-4. An LLC resonant converter is typically formed by a front-end switching bridge (either a half-bridge or a full-bridge), a resonant tank formed by a resonant capacitor and a resonant inductor, a high frequency transformer, and a rectification stage which could be either active, such as a synchronous rectifier (SR), or passive based on diode rectification. When a center tapped transformer is used, the rectification stage can be realized with a half-bridge configuration having two switching devices or diodes rather than using four devices as in full-bridge rectification.

FIG. 2 illustrates a symmetric half-bridge LLC resonant converter topology 200 that includes an inverter 202, also sometimes referred to as a front-end switching bridge, configured to receive a DC input power Vᵢₙ and produce an AC voltage 204. A resonant tank 210 is coupled to the AC voltage 204 where the resonant tank 210 is formed by a resonant inductor Lr, a split resonant capacitance Cᵣ₁/2, Cᵣ₂/2 and a high frequency transformer 206. Diodes D₁, D₂ are disposed in parallel with the resonant capacitors Cᵣ₁/2, Cᵣ₂/2 to facilitate current flow during the output overload or short-circuit condition. The secondary side of the transformer 206 is coupled to the synchronous rectifier 208 to produce DC output power Vₒᵤₜ. A center-tap 248 is included in the transformer 206 secondary winding 222 to drive a half-bridge synchronous rectifier 208 formed of two switching devices SR1, SR2. A filter capacitor Cₒᵤₜ is included to provide filtering of the output power Vₒᵤₜ. The inverter 202 uses a half-bridge configuration with two semiconductor switching devices Q1, Q2 operated at a 50% duty cycle to produce the AC voltage 204.

When operating at high frequencies, parasitic or stray capacitances in the semiconductor switches become significant. These stray capacitances are included in the illustrated converter topology 200 as capacitors C_{OSS_Q1}, C_{OSS_Q2}, C_{OSS_SR1}, C_{OSS_SR2} disposed in parallel with each semiconductor switching device Q1, Q2, SR1, SR2 respectively. Leakage inductances in the secondary winding 222 of the transformer 206 are also significant at higher frequencies and are represented in the topology 200 as inductors L_{lk_s1}, L_{lk_s2}.

In any resonant DC/DC converter topology, such as the converter topology 200, the main feature is a resonant tank 210 designed with a resonant frequency about which the converter is desired to operate. This resonant frequency will be the point at which the converter is most efficient. Load variations on the secondary side may cause the converter operating frequency to move away from the resonant point in order to vary the DC gain and achieve regulation of the output voltage while at the same time maintaining a constant 50% duty cycle on the primary switching devices Q1, Q2, SR1, SR2.

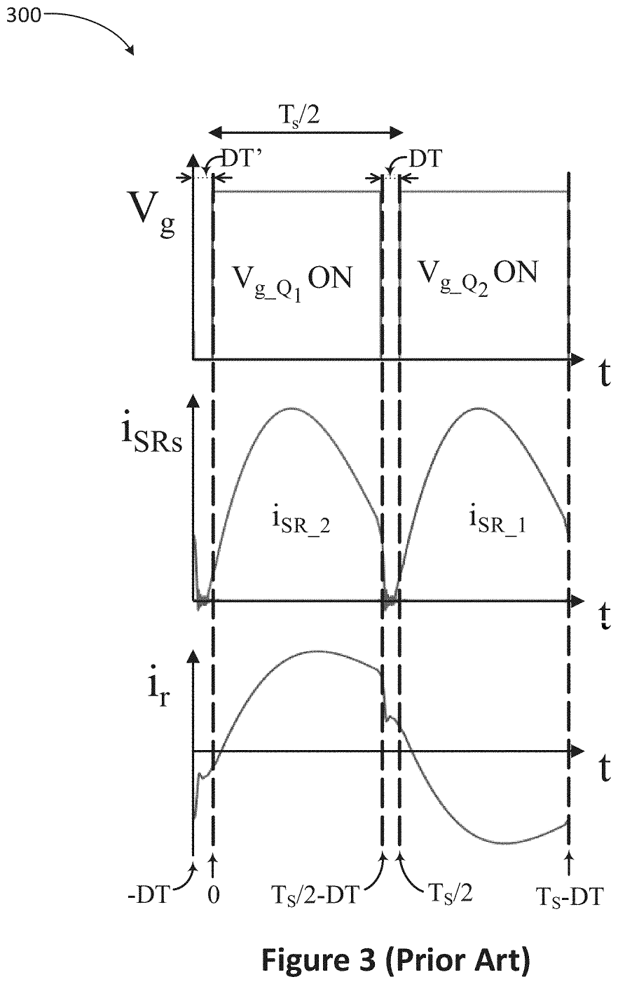

FIG. 3 illustrates graphs 300 showing the main converter waveforms V_{g}, i_{SRS}, iᵣ, associated with the resonant converter topology 200 described above and with reference to FIG. 2. The main converter waveforms include gate voltage V_{g} applied to the gate of inverter switches Q1, Q2, current i_{SRS} through the rectifier switches SR1, SR2, and current iᵣ through the resonant inductor Lᵣ. All waveforms 300 are illustrated at the resonant frequency with a 50% duty cycle.

All graphs 300 share the same horizontal axis depicting time t horizontally increasing to the right. Each graph 300 illustrates one cycle of the converter, shown as the time period −DT≤t≤T_{S}−DT, where T_{S} corresponds to the converter resonant period and DT is a dead time during which the converter switches are transitioning between their on and off states.

During a first time interval where 0≤t≤T_{S}/2−DT, labeled as V_{g_Q1} ON, the gate voltage on the first inverter switch Q1 is active and the first inverter switch Q1 is on, and during a second time interval where T_{S}/2≤t≤T_{S}−DT, labelled as V_{g_Q2} ON, the gate voltage on the second inverter switch Q2 is active and the second inverter switch Q2 is on. During these intervals power is actively transferred from the input power Vᵢₙ to the output power Vₒᵤₜ. These two time intervals, 0≤t≤T_{S}/2−DT and T_{S}/2≤t≤T_{S}−DT, are referred to herein as power cycles or active power transfer periods. Two dead times DT′, DT are included between the active power transfer periods where the gate voltage on both inverter switches Q1, Q2 are zero and the switches Q1, Q2, SR1, SR2 are transitioning between their off and on states.

The middle graph i_{SRs} illustrates the current through the rectifier switching devices SR1 and SR2. During the first time interval where 0≤t≤T_{S}/2−DT, labeled as I_{SR_2}, current is flowing through the rectifier switching device SR2, and during the second time interval where T_{S}/2≤t≤T_{S}−DT, labelled as I_{SR_1}, current is flowing through the rectifier switching device SR1. The bottom graph iᵣ illustrates the current through the resonant inductor Lr.

As it can be seen in the graphs 300, the primary switches, Q1, Q2, operate at a fixed 50% duty cycle including two dead time periods DT′, DT during which the parasitic capacitances C_{OSS_Q1}, C_{OSS_Q2}, C_{OSS_SR1}, C_{OSS_SR2} of the switches Q1, Q2, SR1, SR2 are charged and discharged to facilitate transition of the switches from one state to the other. The dead times DT′, DT, also referred to herein as transition times, must be long enough to ensure zero voltage switching (ZVS) in the main power switching devices Q1, Q2, SR1, SR2. The energy required to perform ZVS is stored in the magnetizing inductance of the transformer Lm during each power cycle and circulates freely during the dead-time.

An understanding of the circuit dynamics of the example power converter 200 may be obtained by considering one semi-cycle of the converter operation. The other semi-cycle is analogous to the first. For the purpose of the following analysis, consider the semi-cycle 0 t≤T_{S}/2. During the period 0≤t≤T_{S}/2−DT, the inverter switch Q1 is on and the converter 200 is actively transferring power from the input power Vᵢₙ to the output power Vₒᵤₜ. During this power cycle, current circulates through the resonant tank 210 and across the transformer 206 to the secondary side 222 to deliver active power to the output power Vₒᵤₜ. Under this active power transfer condition, voltage across the transformer 206 is positive (+Vₚᵣᵢₘ/2) and the rectifier switch SR2 is on, where Vₚᵣᵢₘ/2 is the voltage across the magnetizing inductance. The magnetizing inductance of the transformer 106 is modelled using an inductor Lₘ in parallel with the primary winding 222, the voltage across the magnetizing inductance will be the same as the voltage across the primary winding Vₚᵣᵢₘ. At the same time, the magnetizing inductance Lm is storing energy that will be released during the dead time DT (T_{S}/2−DT≤t≤T_{S}) to achieve ZVS and realize the transition between the inverter switches Q1 and Q2.

A problem exists with the converter topology 200, which becomes significant at high frequencies, such as above about one hundred kilohertz (>100 kHz). At these high frequencies, the leakage inductance L_{lk_s1}, L_{lk_s2} of the secondary transformer winding 222 interact with the stray capacitances C_{OSS_SR1}, C_{OSS_SR2} of the rectifier switches SR1, SR2 leading to overvoltage oscillations around the switching times. When a center-tapped winding 222 is used on the secondary side coupled to a half-bridge rectifier 202, as illustrated in the power converter 200, only half the secondary winding is active during each power transfer period, thereby aggravating the overvoltage oscillations. During each power transfer period the half of the secondary winding not involved in transferring energy (passive winding portion) accumulates energy and contributes to the resonance between the leakage inductances L_{lk_s1}, L_{lk_s2} of the transformer secondary winding 222, and the stray capacitances C_{OSS_SR1}, C_{OSS_SR2} of the rectifier switches SR1, SR2.

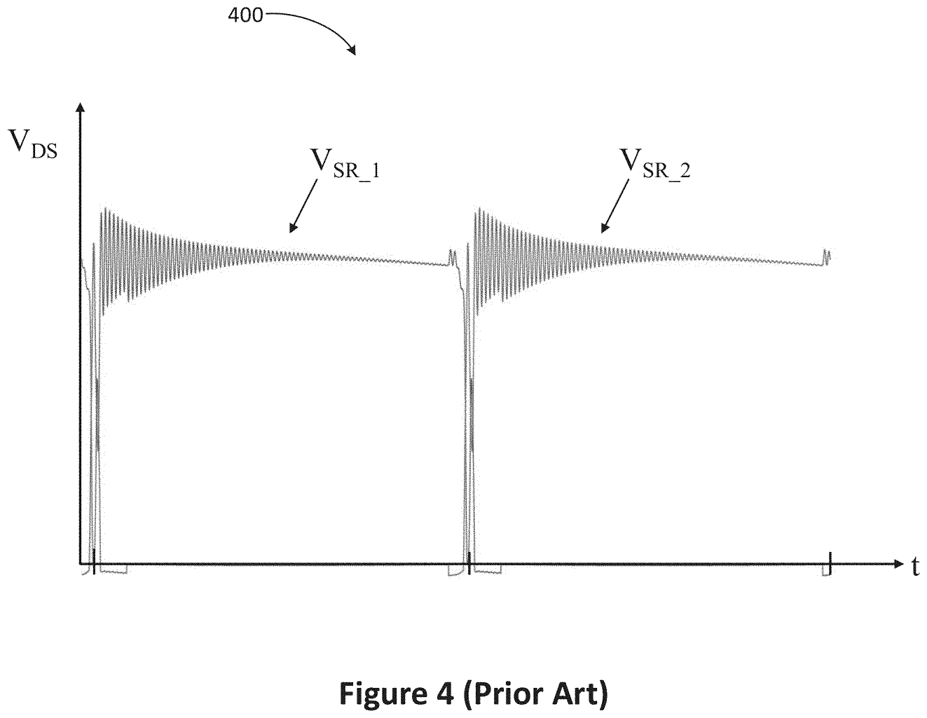

FIG. 4 illustrates a graph 400 showing overvoltage oscillations occurring on the synchronous rectifier switches SR1, SR2 in the converter topology 200. The graph 400 depicts time t horizontally increasing to the right and depicts drain to source voltage V_{D}S vertically increasing upwards. The drain to source voltage of the first switch SR1 is shown during the first half cycle labelled V_{SR_1}, and the drain to source voltage of the second switch SR2 is shown during the second half cycle V_{SR_2}. These overvoltage oscillations V_{SR_1}, V_{SR_2} can damage the semiconductor switches SR1, SR2 used in the rectifier 208 when they exceed voltage ratings of the switching devices used, and can cause an undesirable high frequency ringing from an electromagnetic compatibility (EMC) point of view. Additionally, the overvoltage oscillations translate into undesirable losses that can reduce the converter efficiency.

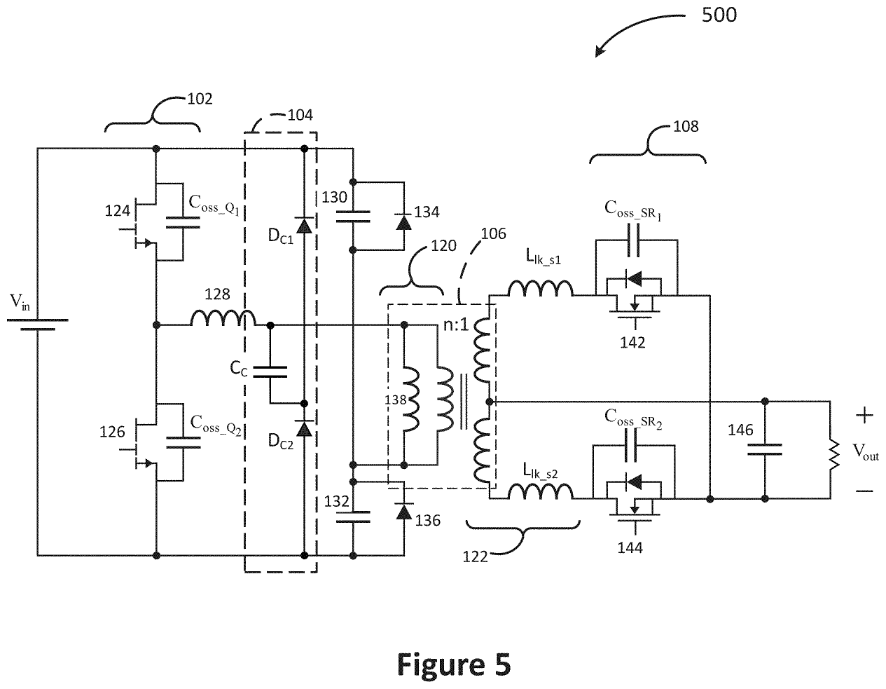

FIG. 5 illustrates a symmetric LLC resonant converter topology 500 including an energy recovery auxiliary circuit 104 incorporating aspects of example embodiments. The power converter topology 500 is similar to the power converter topology 100 described above and with reference to FIG. 1 where like numerals indicate like elements. As an aid to understanding the power converter topology 500 includes elements that model parasitic effects of some of the converter components. Stray capacitances of the semiconductor switches 124, 126, 142, 144 are modelled with a capacitor C_{OSS_Q1}, C_{OSS_Q2}, C_{OSS_SR1}, C_{OSS_SR2} disposed in parallel with each semiconductor switching device 124, 126, 142, and 144 respectively. Leakage inductance of the transformer secondary winding 122 is modelled with inductances L_{lk_s1}, L_{lk_s2} disposed in series with each end of the transformer secondary 122 winding.

As an aid to understanding the following discussion considers a power factor correction (PFC) application where a rectified AC input power is modelled as an input DC power source Vᵢₙ and any harmonic content is neglected. The considered application provides a voltage step-down where the output power Vₒᵤₜ has a lower voltage than the input power Vᵢₙ and the transformer turns ratio n:1 has n greater than 1. An example of this type of application would be a converter used to provide a low voltage, such as twelve volts, to a computer server. To minimize the number of components in the considered example and aid understanding, a center-tapped transformer is used to drive a half-bridge rectifier 108 in the illustrated converter 500. As will be discussed further below, the illustrated energy recovery auxiliary circuit 104 may also be advantageously employed to supress overvoltage oscillations in converters employing a full-bridge inverter and/or a full-bridge rectifier realization.

Operating the power converter 500 at high frequencies, such as above about one hundred kilohertz (>100 kHz). can reduce the size of magnetic components and improve power density of the converter. For example, the illustrated converter 500 may be advantageously operated at about one megahertz (1 MHz) with the operating frequency being varied by plus or minus about three percent to provide regulation of the output power Vₒᵤₜ. Operation at these frequencies may be achieved with semiconductor switches 124, 126 being fast-switching devices such as Gallium Nitride (GaN) switches on the primary side of the transformer 106, along with semiconductor switches 142, 144 being fast switching MOSFETS (Metal-Oxide-Semiconductor Field-Effect-Transistor) in the rectifier 108 on the secondary side of the transformer 106.

To fully understand the operating principles of the energy recovery auxiliary circuit 104, it is constructive to analyse the transition period DT during which semiconductor switches 124, 126, being half-bridge switches, are transitioning between their conductive and non-conductive states. As describe above with reference to FIGS. 2 and 3, during the dead-time DT, transition between the high semiconductor switches 124, 142 and low semiconductor switches 126, 144 on the primary and secondary side of the transformer 106 takes place. During this dead time DT, a freewheeling current will circulate in order to charge and discharge the stray or parasitic capacitances C_{OSS_Q1}, C_{OSS_Q2}, C_{OSS_SR1}, C_{OSS_SR2} of the semiconductor switches 124, 126, 142, 144.

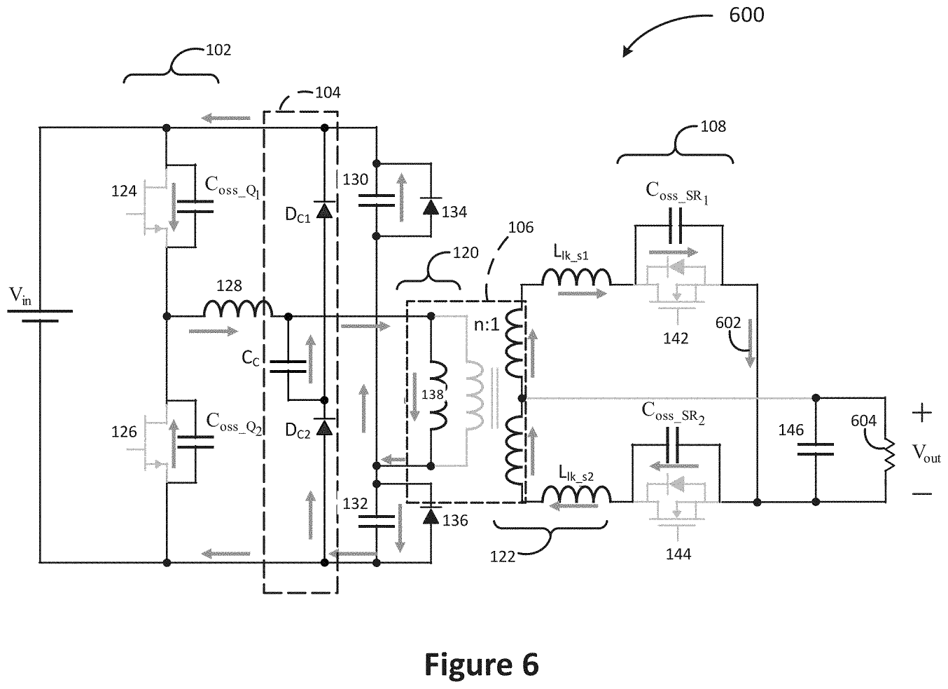

FIG. 6 illustrates freewheeling currents flowing in a symmetric LLC resonant converter topology 600 incorporating aspects of example embodiments. The power converter topology 600 illustrates the same power converter topology 500 described above and with reference to FIG. 5 during a transition time DT where all the semiconductor switches 124, 126, 142, 144 are off. Arrows, such as the arrow symbol indicated by numeral 602, are used to depict the direction and presence of freewheeling current flowing in various circuit segments during a transition time DT.

For clarity, FIG. 6 illustrates freewheeling current circulation in the power converter topology 600 during the same transition period DT described above and with reference to FIGS. 2 and 3. The illustrated transition interval DT reflects the period between the turning off of semiconductor switch 124 (while semiconductor switch 126 is already off) and the turning on of semiconductor switch 126. During this time, the voltage across the primary side 120 of the transformer 106 changes from positive (+Vm/2) to negative (−Vₚᵣᵢₘ/2), where Vₚᵣᵢₘ represents the voltage across the magnetizing inductance 138.

The freewheeling currents will be most critical on the secondary 122 side of the transformer 106 where the transformer's leakage inductances L_{lk_s1}, L_{lk_s2} are most significant and high current is delivered to the load 604. As described above and with reference to FIG. 4 a resonance can occur in conventional power converters due to the interaction of the leakage inductances L_{lk_s1}, L_{lk_s2} with the stray capacitances C_{OSS_SR1}, C_{OSS_SR2} of the semiconductor switches 142, 144 resulting in an overvoltage ringing or oscillation across the semiconductor switches 142, 144.

Conventional approaches for mitigating effects of these overvoltage oscillations employ adding damping circuitry on the secondary side of the transformer. The added circuitry increases complexity and cost of the converter, and because higher currents are flowing on the secondary side, increased losses may occur resulting in reduced converter efficiency. Certain conventional solutions employ active damping on the secondary side to supress the overvoltage oscillations. However, active damping requires additional semiconductor components and increases complexity of the associated control circuitry. Active damping solutions also suffer from reduced efficiency due to the energy lost to damping.

As disclosed herein, suppression of the overvoltage oscillations can be effectively accomplished using an apparatus, such as the energy recovery auxiliary circuit 104 described above, disposed on the primary 120 side of the transformer 106 where currents are lower in magnitude and there exists opportunity to recover the energy of the overvoltage oscillations. Primary side suppression and energy recovery may be achieved using the energy recovery auxiliary circuit 104 described above and with reference to FIGS. 1, 5 and 6. The energy recovery auxiliary circuit 104 is configured to draw current from the secondary side 122 during the transition period DT thereby mitigating the ringing effect. The secondary side current stored in the transformer's leakage inductances L_{lk_s1}, L_{lk_s2} will pass through the transformer to the primary side and will flow through the low impedance energy recovery auxiliary circuit 104, thereby charging and discharging the clamping capacitor C_{C}.

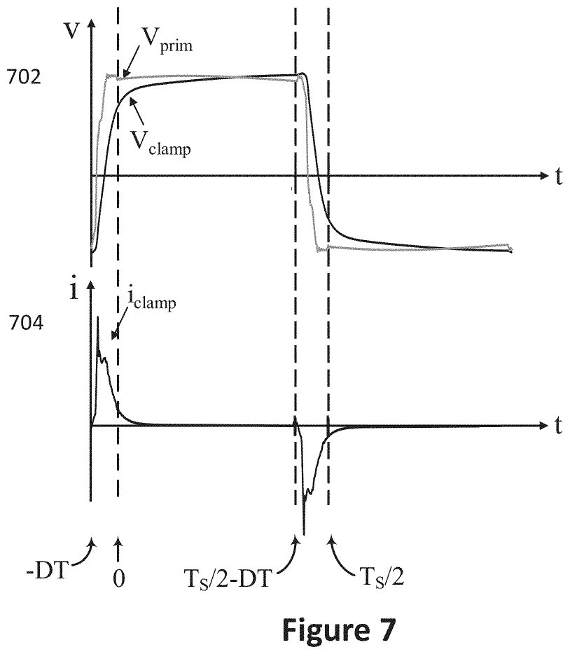

FIG. 7 illustrates graphs 702, 704 showing operating waveforms of an energy recovery auxiliary circuit 104 incorporating aspects of the example embodiments. Graphs 702 and 704 depict time increasing to the right along a horizontal axis t. The time interval −DT≤t≤T_{S}−DT illustrated in graphs 702 and 704 corresponds to the time interval −DT≤t≤T_{S}−DT described above and with respect to FIG. 3. Graph 702 depicts voltage increasing upwards along a vertical axis v, and graph 704 depicts current increasing upwards along a vertical axis i.

Graph 702 shows voltage Vₚᵣᵢₘ across the transformer primary winding 120, and voltage V_{clamp} of the clamping capacitor C_{C}. Voltage across the clamping capacitor V_{clamp} mirrors the voltage across the transformer's primary winding Vₚᵣᵢₘ with a slight delay as shown in graph 702. Graph 704 shows the current flowing in the clamping capacitor C_{C} during the corresponding time period as shown in graph 702.

A part of the resonant current flows through the energy recovery auxiliary circuit 104 to discharge the clamping capacitor C_{C} and to change the voltage across the clamping capacitor C_{C} from +Vᵢ/2 to −Vᵢ/2, where Vᵢ is a voltage of the input power Vᵢₙ. Part of the current stored in the secondary side winding 122 inductances will no longer flow through the stray capacitances of the rectifier switches as was the case in the conventional converter described above, but will instead flow through a lower impedance path to the energy recovery auxiliary circuit 104 on the primary side via the transformer 106. The energy stored in the clamping capacitor C_{C} will be released during a subsequent power cycle back to the input power Vᵢₙ, thereby improving overall efficiency of the power converter apparatus 100.

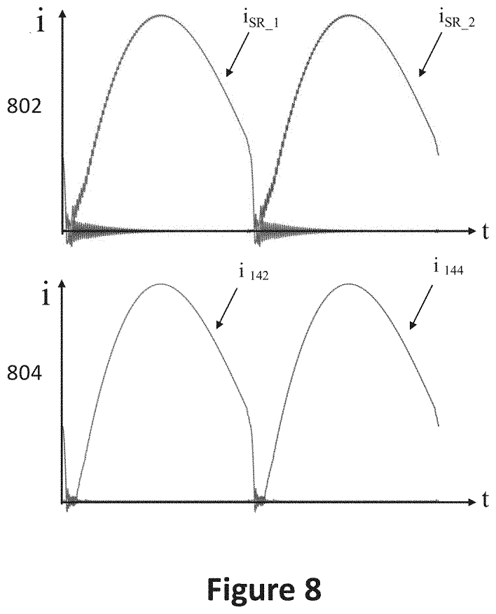

FIG. 8 illustrates graphs 802 and 804 comparing the rectifier current of conventional power converter topologies to the improved power converter topologies incorporating aspects of the present disclosure. Graphs 802 and 804 depict time increasing to the right along a horizontal axis t. Current is depicted in graphs 802 and 804 increasing upwards along a vertical axis i. Both graphs 802 and 804 illustrate the same time interval as illustrated in FIGS. 3 and 7. Graph 802 shows current I_{SR_1} and I_{SR_2} flowing through the rectifier switches SR1 and SR2 respectively in the conventional converter topology 200 described and with reference to FIG. 2. Graph 804 illustrates current i₁₄₂ and i₁₄₄ flowing through the semiconductor switches 142 and 144 respectively in the example converter apparatus 100 described above and with respect to FIG. 1. Graph 804 shows the significant reductions in current ringing provided by the energy recovery auxiliary circuit 104.

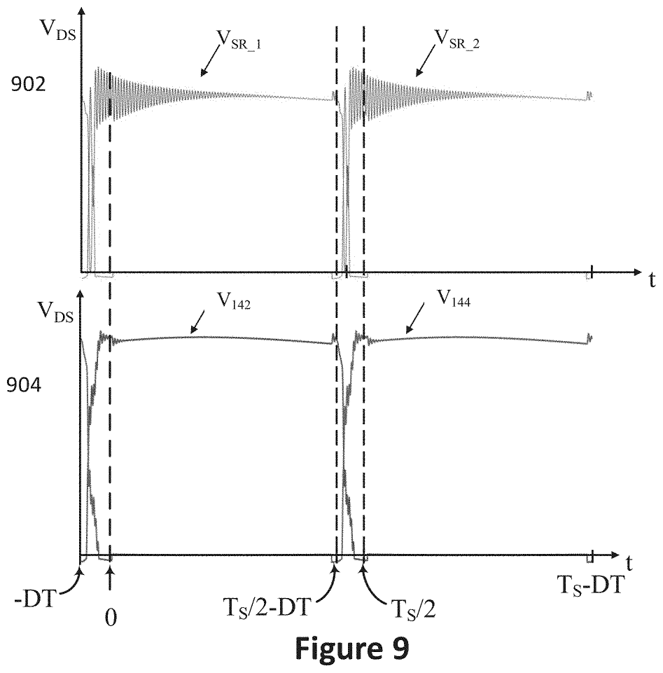

FIG. 9 illustrates graphs 902 and 904 comparing drain to source voltages of rectifier switches in conventional power converter topologies to corresponding voltages in the example power converter topologies incorporating aspects of example embodiments. Graphs 802 and 804 depict time increasing to the right along a horizontal axis t. Graphs 902 and 904 illustrate the same time interval as shown in graphs 802 and 804 described above, which is the same time interval illustrated in FIGS. 3 and 7. Graph 902 shows the drain to source voltage V_{SR_1} and V_{SR_2} on the rectifier switches SR1 and SR2 respectively of the conventional converter topology 200 described above and with reference to FIG. 2. Graph 904 shows the drain to source voltage V₁₄₂ and V₁₄₄ on the semiconductor switches 142 and 144 respectively of the example converter apparatus 100 described above and with reference to FIG. 1. Graph 904 illustrates the significant reduction in overvoltage oscillations provided by the energy recovery auxiliary circuit 104.

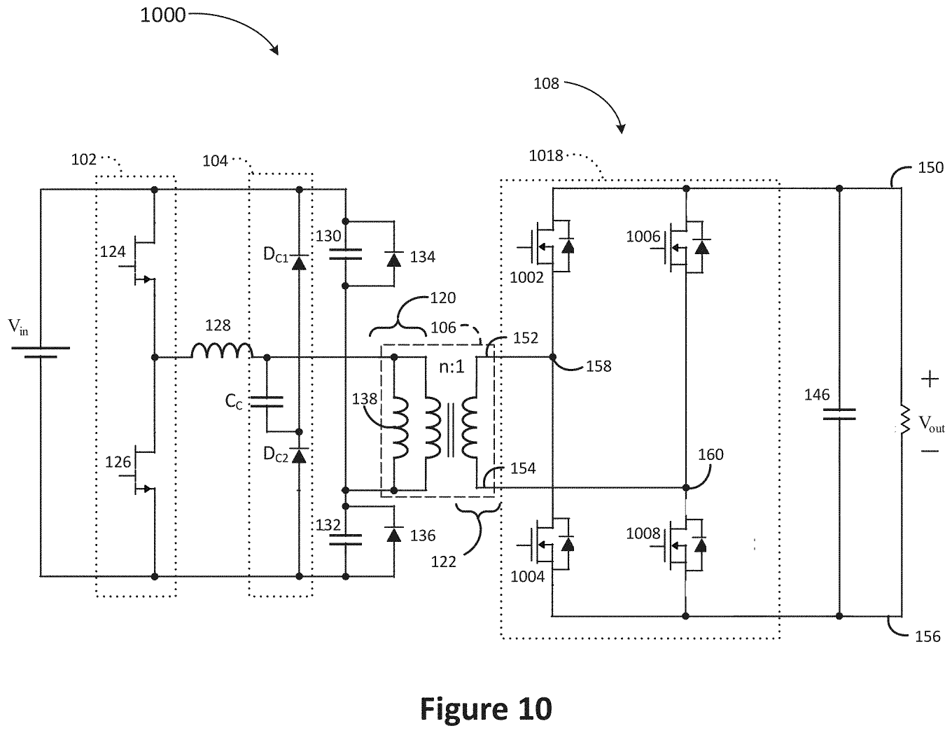

FIG. 10 illustrates a symmetric half-bridge resonant LLC converter topology with full-bridge rectification incorporating aspects of example embodiments. The example power converter apparatus 1000 is similar to the example converter apparatus 100 described above and with reference to FIG. 1 where like numerals indicate like elements. In contrast to the example converter apparatus 100, in which the rectifier 108 comprises a half-bridge rectifier, the rectifier 108 of the example power converter 1000 is a full-bridge rectifier 1018.

The full-bridge rectifier 1018 in this example is coupled to each end 152, 154 of the transformer secondary winding 122. Similar to the operation of the half-bridge rectifier used in the example power converter 100, the full-bridge rectifier 1018 is operated synchronously with the half-bridge inverter 102.

The full-bridge rectifier 1018 includes two semiconductor switches 1002, 1004 coupled in series between the positive DC output voltage 150 and the negative DC output voltage 156. A central node 158 formed between the two semiconductor switches 1002, 1004 is connected to one end 152 of the secondary winding 122. A second pair of semiconductor switches 1006, 1008 is also coupled in series between the positive DC output voltage 150 and the negative DC output voltage 156. A central node 160 is formed between the two semiconductor switches 1006, 1008 and is connected to a second end 154 of the transformer secondary winding 122. Other than the use of the full-bridge rectifier 1018 coupled to the two ends 152, 154 of the secondary winding 122, the remainder of the example power converter apparatus 1000 is the same as the example power converter apparatus 100 described above. Notably, the energy recovery auxiliary circuit 104 operates in the same way and provides corresponding benefits reducing overvoltage oscillations on the secondary side and recovering the energy from the oscillations.

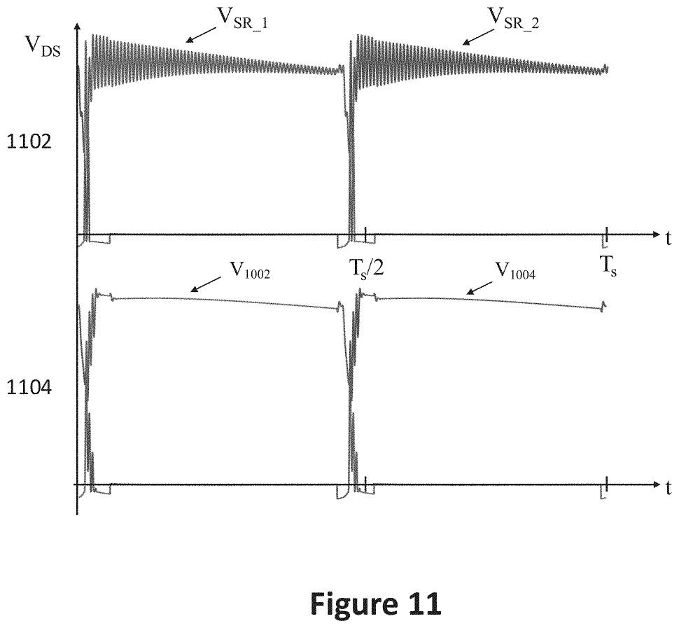

FIG. 11 illustrates graphs 1102 and 1104 comparing drain to source voltages VDS of rectifier switches in conventional power converter topologies to corresponding voltages in the example power converter apparatus 1000 of FIG. 10. Graphs 1102 and 1104 depict time increasing to the right along a horizontal axis t. Graphs 1102 and 1104 illustrate the same time interval as shown in graphs 902 and 904 described above. Graph 1102 shows the drain to source voltage V_{SR_1} and V_{SR_2} on the rectifier switches SR1 and SR2 respectively of a conventional converter topology 200. Graph 1104 shows the drain to source voltage V₁₀₀₂ and V₁₀₀₄ on the rectifier switches 1002 and 1004 respectively of the example converter apparatus 1000 described above and with reference to FIG. 10. Graph 1104 shows the significant reduction in overvoltage oscillations provided by the energy recovery auxiliary circuit 104.

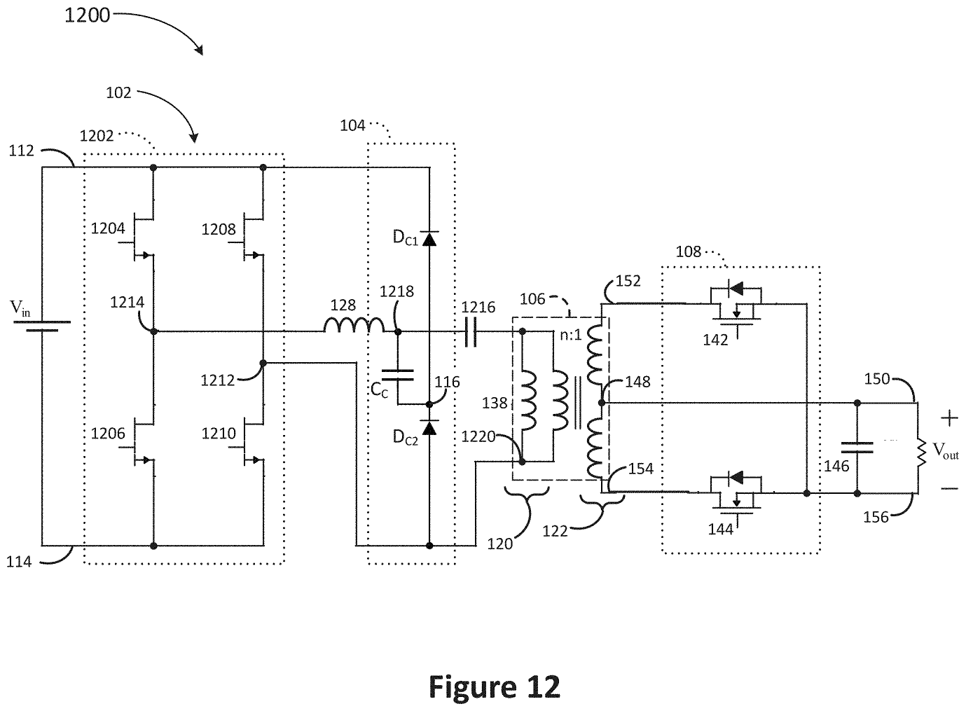

In the example of FIG. 12, the power converter apparatus 100 is a full-bridge resonant LLC converter topology incorporating aspects of example embodiments. The example power converter apparatus 1200 of FIG. 12 is similar to the example power converter apparatus 100 described above and with reference to FIG. 1 where like numerals indicate like elements. In contrast to the example power converter apparatus 100 in which the inverter 102 is a half-bridge inverter, the inverter 102 of the example power converter apparatus 1200 of FIG. 12 employs a full-bridge inverter 1202. The full-bridge inverter 1202 is configured to produce an AC voltage across nodes 1212 and 1214.

In the example of FIG. 12, a pair of semiconductor switches 1204, 1206 is coupled in series between the positive DC input voltage 112 and the negative DC input voltage 114. Another pair of semiconductor switches 1208, 1210 is also coupled in series between the positive DC input voltage 112 and the negative DC input voltage 114. In certain embodiments the four semiconductor switches 1204, 1206, 1208, 1210 are operated as a full-bridge inverter to create a first AC voltage at a central node 1212, referred to as first AC voltage 1212, between the switch 1208 and switch 1210, and create a second AC voltage at a central node 1214, referred to as second AC voltage 1214, between switch 1204 and 1206.

The second AC voltage 1214 is coupled to a resonant tank made up of a series connected resonant inductor 128, resonant capacitor 1216, and the primary winding 120 of the transformer 106. The first AC voltage 1212 is connected to another end 1220 of the primary winding 120 of the transformer 106.

In the example power converter 1200 the full-bridge inverter 1202 is employed and the series connected diodes D_{C1}, D_{C2} of the energy recovery auxiliary circuit 104 are coupled between the positive DC input voltage 112 and an end 1220 of the primary winding 120. A clamping capacitor C_{C} is coupled between a central node 116 of the auxiliary circuit 104 and an end 1218 of the resonant inductor 128. This allows current to be drawn through a lower impedance path from the transformer secondary winding 122 through the transformer into the clamping capacitor C_{C} during a transition period DT, thereby providing damping of overvoltage oscillations that could occur on the secondary side 122 of the transformer 106. The energy stored on the clamping capacitor C_{C} will then be returned to the DC input power Vᵢₙ during a subsequent power cycle.

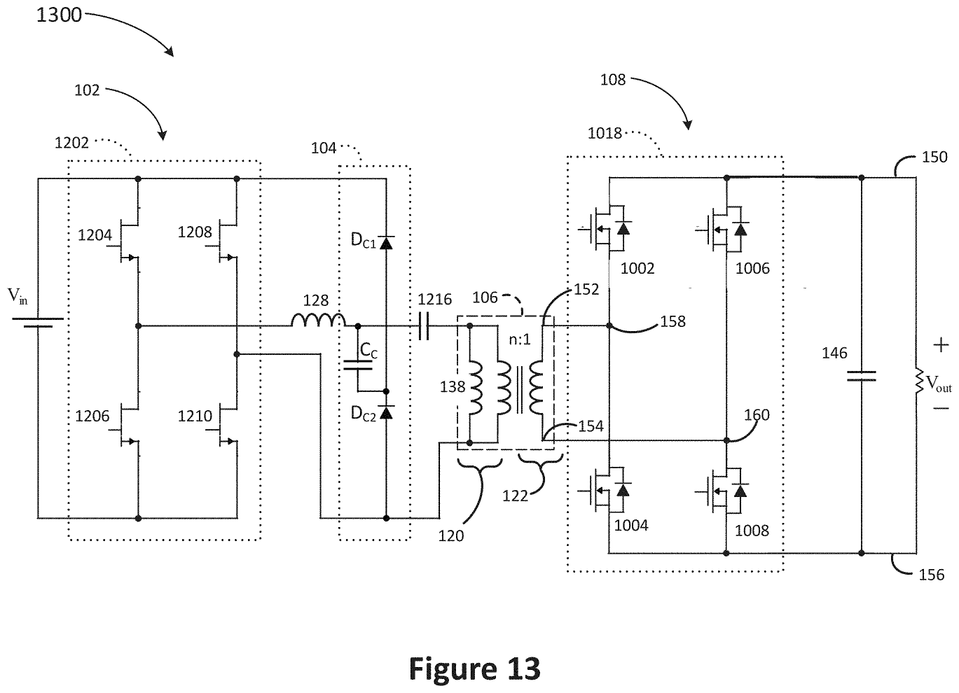

FIG. 13 illustrates another embodiment of the power converter apparatus 100 of FIG. 1. In this example, the power converter apparatus 1300 is a full-bridge resonant LLC converter topology with full-bridge rectification. The example power converter apparatus 1300 is similar to the example power converter apparatus 1200 described above and with reference to FIG. 12 where like numerals indicate like elements. In contrast to the example power converter apparatus 1200 of FIG. 12 in which the rectifier 108 is a half-bridge rectifier, similar to what is also shown in FIG. 1, the rectifier 108 of the example power converter apparatus 1300 of FIG. 13 is a full-bridge rectifier 1018. The full-bridge rectifier 1018 in this example is similar to the full-bridge rectifier 1018 described above and with reference to FIG. 10 and is configured to produce the DC output power Vₒᵤₜ.

The full-bridge rectifier 1018 of FIG. 13 includes two semiconductor switches 1002, 1004 coupled in series between the positive DC output voltage 150 and the negative DC output voltage 156. A central node 158 formed between the two semiconductor switches 1002, 1004 is connected to one end 152 of the secondary winding 122. A second pair of semiconductor switches 1006, 1008 is also coupled in series between the positive DC output voltage 150 and the negative DC output voltage 156. A central node 160 formed between the two semiconductor switches 1006, 1008 is connected to a second end 154 of the transformer secondary winding 122. Other than the use of the full-bridge rectifier 1018 coupled to the two ends 152, 154 of the secondary winding 122, the remainder of the example power converter 1300 is the same as the example power converter 1200 described above. Notably, the energy recovery auxiliary circuit 104 operates in the same way and provides corresponding benefits reducing overvoltage oscillations on the secondary side and recovering the energy used to reduce the oscillations.

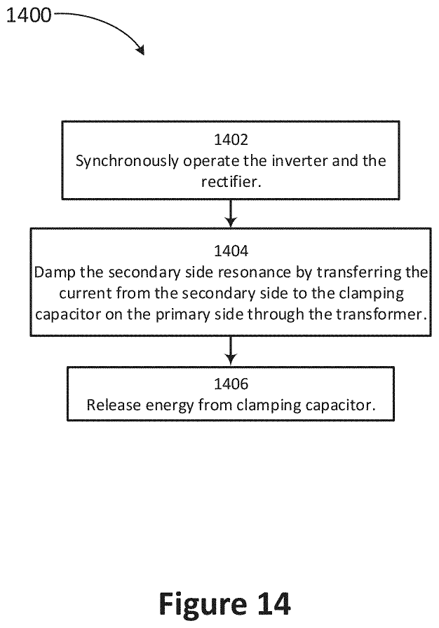

FIG. 14 illustrates a flow diagram of an example method for supressing overvoltage ringing in a resonant LLC converter topology incorporating aspects of example embodiments. The example method 1400 is applicable to a variety of resonant LLC power converters that include an inverter configured to receive an input DC power and produce an AC power, a resonant tank coupled to the AC power and including a resonant inductor coupled to a primary winding of a transformer, a rectifier coupled to a secondary side of the transformer and configured to produce an output power; and, a clamping capacitor conductively coupled between the resonant inductor and the primary winding. The example method 1400 is appropriate for use in any of the example power converter apparatus topologies 100, 1000, 1200, 1300 described herein above.

The example method 1400 synchronously operates 1402 the inverter and the rectifier to maintain the power cycle and transition times of both the inverter and rectifier aligned in time. This alignment in time facilitates the use of an energy recovery auxiliary circuit, such as the auxiliary circuit 104 described above, to be used to supress, during the transition time, oscillations occurring on the secondary side with an auxiliary circuit on the primary side.

Oscillations on the secondary side are damped 1404 by transferring current from the secondary transformer winding through the transformer to the primary side and storing the transferred energy onto a clamping capacitor which is conductively coupled to the transformer primary winding. This current transfer effectively supresses overvoltage oscillations that may otherwise occur on the secondary side due to the interaction between the leakage inductance of the secondary transformer winding and the stray capacitance of rectifier switches.

During a subsequent power cycle, the energy stored in the clamping capacitor is released 1406 back to the input DC voltage. By recovering the energy stored in the clamping capacitor, the overall efficiency of the power converter is improved.

Thus, while there have been shown, described and pointed out, fundamental novel features of the invention as applied to the example embodiments thereof, it will be understood that various omissions, substitutions and changes in the form and details of devices and methods illustrated, and in their operation, may be made by those skilled in the art without departing from the spirit and scope of the presently disclosed invention. Further, it is expressly intended that all combinations of those elements, which perform substantially the same function in substantially the same way to achieve the same results, are within the scope of the invention. Moreover, it should be recognized that structures and/or elements shown and/or described in connection with any disclosed form or embodiment of the invention may be incorporated in any other disclosed or described or suggested form or embodiment as a general matter of design choice.

What is claimed is:

1. An apparatus comprising:
an inverter configured to receive a DC input power (Vᵢₙ) and produce an AC voltage;
a first capacitor and a second capacitor coupled in series between a positive DC input voltage and a negative DC input voltage forming a first central node between the first capacitor and the second capacitor;
a transformer comprising a primary winding and a secondary winding, wherein the primary winding is coupled to the first central node;
a resonant inductor coupled between the AC voltage and the primary winding;
a rectifier coupled to the secondary winding and configured to produce a DC output power (Vₒᵤₜ); and
an auxiliary circuit, wherein the auxiliary circuit comprises a first diode (D_{C1}) and a second diode (D_{C2}) coupled in series between the positive DC input voltage and the negative DC input voltage, and a clamping capacitor (C_{C}) coupled between the resonant inductor and a central node between the first diode (D_{C1}) and the second diode (D_{C2}).

2. The apparatus of claim 1, wherein the inverter comprises a first semiconductor switch and a second semiconductor switch coupled in series between the positive DC input voltage and the negative DC input voltage.

3. The apparatus of claim 1, wherein the secondary winding comprises a center tap coupled to a first DC output voltage and the rectifier comprises:
a third semiconductor switch coupled between a first end of the secondary winding and a second DC output voltage; and
a fourth semiconductor switch coupled between a second end of the secondary winding and the second DC output voltage.

4. The apparatus of claim 1, wherein the rectifier comprises:
a fifth semiconductor switch coupled between a first end of the secondary winding and a first DC output voltage;
a sixth semiconductor switch coupled between the first end of the secondary winding and a second DC output voltage;
a seventh semiconductor switch coupled between a second end of the secondary winding and the first DC output voltage; and
an eighth semiconductor switch (1008) coupled between the second end (154) of the secondary winding and the second DC output voltage.

5. The apparatus of claim 1 further comprising a third diode coupled in parallel with the first capacitor, and a fourth diode coupled in parallel with the second capacitor.

6. An apparatus comprising:
an inverter configured to receive a DC input power (Vᵢₙ) and produce a first AC voltage and a second AC voltage;
a resonant tank coupled between the first AC voltage and the second AC voltage, the resonant tank comprising a resonant inductor coupled in series with a resonant capacitor coupled to the primary winding of a transformer;
a rectifier coupled to a secondary winding of the transformer, wherein the rectifier is configured to produce a DC output power (Vₒᵤₜ); and
an auxiliary circuit, wherein the auxiliary circuit comprises a first diode (D_{C1}) and a second diode (D_{C2}) coupled in series between a first DC input voltage and the first AC voltage having a first central node, and a clamping capacitor (C_{C}) coupled between a first end of the resonant inductor and the first central node.

7. The apparatus of claim 6 wherein the inverter comprises:
a first semiconductor switch and a second semiconductor switch coupled in series between the positive DC input voltage and a negative DC input voltage configured to produce the second AC voltage;
a third semiconductor switch and a fourth semiconductor switch coupled in series between the positive DC input voltage and the negative DC input voltage and configured to produce the first AC voltage.

8. The apparatus of claim 6 wherein the secondary winding comprises a center tap coupled to a first DC output voltage and wherein the rectifier comprises:
a fifth semiconductor switch coupled between a first end of the secondary winding and a second DC output voltage; and
a sixth semiconductor switch coupled between a second end of the secondary winding and the second DC output voltage.

9. The apparatus of claim 6, wherein the rectifier comprises:
a seventh semiconductor switch coupled between the first end of the secondary winding and the positive DC output voltage;
an eighth semiconductor switch coupled between the first end of the secondary winding and the negative DC output voltage;
a ninth semiconductor switch coupled between the second end of the secondary winding and the positive output voltage; and
a tenth semiconductor switch coupled between the second end (154) of the secondary winding and the negative output voltage.

10. A method for operating a DC/DC power converter, wherein the converter comprises:
an inverter configured to receive an input DC power and produce an AC power:
a resonant tank coupled to the AC power and comprising a resonant inductor coupled to a primary winding of a transformer;
a rectifier coupled to a secondary side of the transformer and configured to produce an output power; and
a clamping capacitor conductively coupled between the resonant inductor and the primary winding,
and wherein the method comprises:
synchronously operating the inverter and the rectifier to create a transition period followed by a power delivery period;
transferring, during the transition period, a current from the secondary side through the transformer to the primary winding and then to the clamping capacitor; and
releasing, during the power delivery period, electrical power from the clamping capacitor to the input power.
